(19) United States
(12) Patent Application Publication
(10) Pub. No.: US 2008/0141834 A1
(43) Pub. Date: Jun. 19, 2008

(54) Socket

(76) Inventor: Yao-Hung Wang, Tai-Ping City (TW)

Correspondence Address: CHARLES E. BAXLEY, ESQ., 90 JOHN STREET, THIRD FLOOR, NEW YORK, NY, 10038, US

(21) Appl. No.: 11/640,717

(22) Filed: Dec. 18, 2006

(51) Int. Cl. B25F 1/02

(52) U.S. Cl. 81/121.1; 81/437

(57) ABSTRACT

A socket includes socket body having a first end formed with a connecting recess, a second end formed with a driving recess and a mediate portion formed with a separation portion which is located between the connecting recess and the driving recess and is formed with an auxiliary driving hole which is connected between the connecting recess and the driving recess. Thus, the socket can be driven by a socket wrench and a screwdriver, thereby enhancing the versatility of the socket, and thereby facilitating a user operating the socket.

### BACKGROUND OF THE INVENTION

1. Field of the Invention

The present invention relates to a socket, and more particularly to a socket having two different driving functions so that the socket is available for a socket wrench and a screwdriver.

2. Description of the Related Art

A conventional socket in accordance with the prior art shown in FIG. 13 comprises a socket body 40 having a first end formed with a connecting recess 41, a second end formed with a driving recess 43 and a mediate portion formed with a circular hole 42 between the connecting recess 41 and the driving recess 43.

In fabrication, the circular hole 42 is connected between the connecting recess 41 and the driving recess 43 so that the inner faces of the connecting recess 41 and the driving recess 43 are electroplated evenly during the plating process.

In operation, when the socket body 40 is mounted on a bolt (not shown) or nut, the driving recess 43 of the socket body 40 is mounted on the bolt head of the bolt. Then, a socket wrench (not shown) has a square head inserted into the connecting recess 41. Thus, the driving recess 43 of the socket body 40 and the square head of the socket wrench are combined together, so that when the socket wrench is rotated, the socket body 40 is driven by the socket wrench to rotate the bolt. Thus, the socket can be driven by the socket wrench.

However, the conventional socket is only available the socket wrench, thereby causing inconvenience to the user when the socket wrench is missed. In addition, the socket wrench is perpendicular to the socket, so that the socket wrench and the socket need a larger space of operation and cannot be operated in a narrow space.

### SUMMARY OF THE INVENTION

The present invention is to mitigate and/or obviate the disadvantage of the conventional socket.

The primary objective of the present invention is to provide a socket having two different driving functions so that the socket is available for a socket wrench and a screwdriver.

Another objective of the present invention is to provide a socket that can be driven by a socket wrench and a screwdriver, thereby enhancing the versatility of the socket, and thereby facilitating a user operating the socket.

A further objective of the present invention is to provide a socket that co-operates with the screwdriver to reduce the space of operation so that the socket co-operating with the screwdriver can be operated in a narrow space.

A further objective of the present invention is to provide a socket, wherein the auxiliary driving hole has different shapes to correspond to screwdrivers of different shapes.

In accordance with the present invention, there is provided a socket, comprising a socket body having a first end formed with a connecting recess, a second end formed with a driving recess and a mediate portion formed with a separation portion which is located between the connecting recess and the driving recess and is formed with an auxiliary driving hole which is connected between the connecting recess and the driving recess.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a socket in accordance with the preferred embodiment of the present invention;

FIG. 2 is a perspective cross-sectional view of the socket as shown in FIG. 1;

FIG. 3 is a top view of the socket as shown in FIG. 1;

FIG. 4 is a front cross-sectional operational view of the socket as shown in FIG. 1;

FIG. 5 is a top view of a socket in accordance with another preferred embodiment of the present invention;

FIG. 6 is a top view of a socket in accordance with another preferred embodiment of the present invention;

FIG. 7 is a top view of a socket in accordance with another preferred embodiment of the present invention;

FIG. 8 is a top view of a socket in accordance with another preferred embodiment of the present invention;

FIG. 9 is a top view of a socket in accordance with another preferred embodiment of the present invention;

FIG. 10 is a top view of a socket in accordance with another preferred embodiment of the present invention;

FIG. 11 is a top view of a socket in accordance with another preferred embodiment of the present invention;

FIG. 12 is a top view of a socket in accordance with another preferred embodiment of the present invention;

FIG. 13 is a perspective cross-sectional view of a conventional socket in accordance with the prior art.

### DETAILED DESCRIPTION OF THE INVENTION

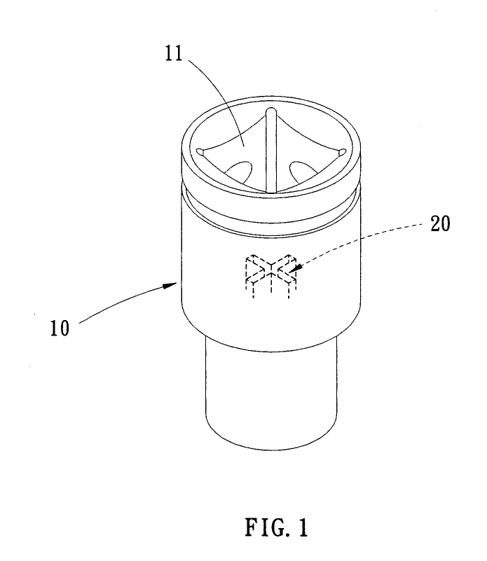

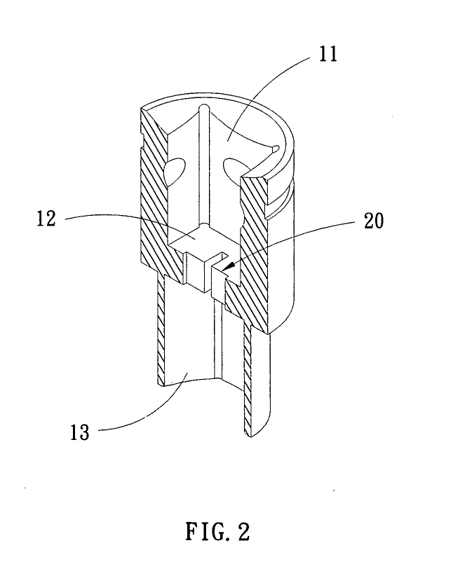

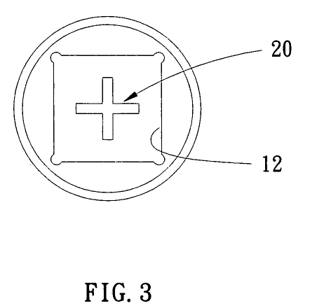

Referring to the drawings and initially to FIGS. 1-3, a socket in accordance with the preferred embodiment of the present invention comprises a socket body 10 having a first end formed with a connecting recess 11 having a square shape, a second end formed with a driving recess 13 having a hexagonal shape and a mediate portion formed with a separation portion 12 which is located between the connecting recess 11 and the driving recess 13 and is formed with an auxiliary driving hole 20 which is connected between the connecting recess 11 and the driving recess 13.

The connecting recess 11, the auxiliary driving hole 20 and the driving recess 13 are arranged in an axial direction of the socket body 10. The separation portion 12 is perpendicular to the axial direction of the socket body 10. The separation portion 12 has a thickness extending along the axial direction of the socket body 10, and the auxiliary driving hole 20 is extended through the whole thickness of the separation portion 12. The auxiliary driving hole 20 has a non-circular shape. In the preferred embodiment of the present invention, the auxiliary driving hole 20 has a substantially cross shape.

Referring to FIG. 4, when the socket body 10 is mounted on a bolt 50, the driving recess 13 of the socket body 10 is mounted on the bolt head of the bolt 50. Then, a screwdriver 30 has a cross-headed tip 31 that is extended through the connecting recess 11 into the auxiliary driving hole 20. Thus, the auxiliary driving hole 20 of the socket body 10 and the cross-headed tip 31 of the screwdriver 30 are combined together, so that when the screwdriver 30 is rotated, the socket body 10 is driven by the screwdriver 30 to rotate the bolt 50. Thus, the socket body 10 can be driven by a socket wrench (not shown) and a screwdriver 30, thereby facilitating a user operating the socket.

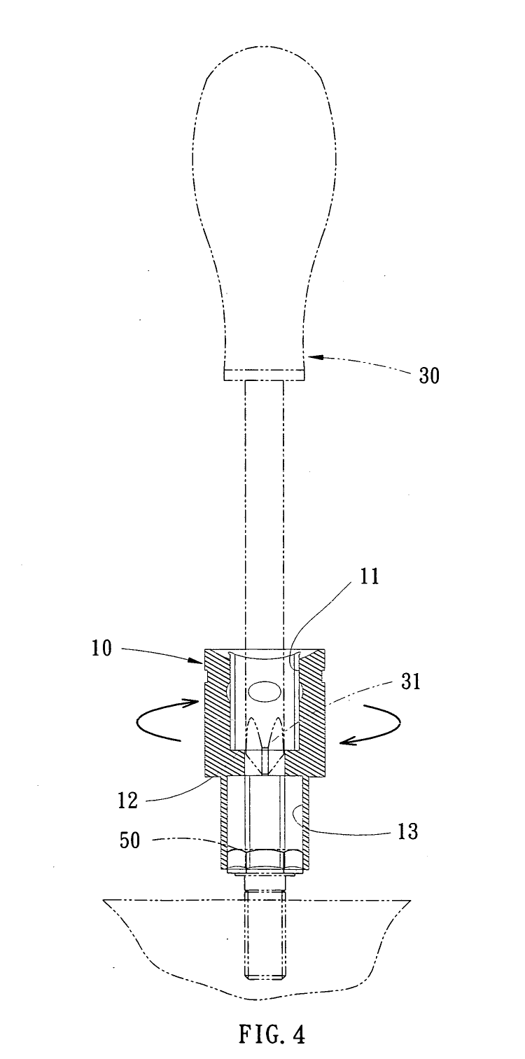

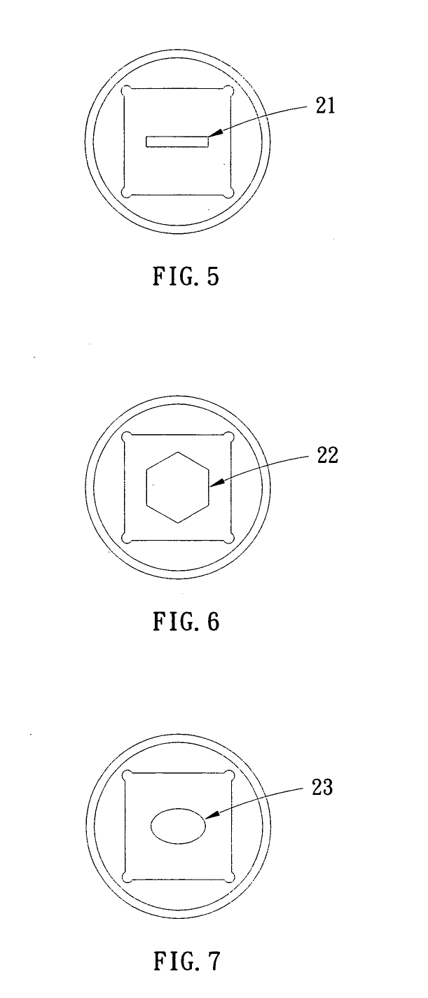

Referring to FIG. 5, the auxiliary driving hole 21 has a substantially flat shape.

Referring to FIG. 6, the auxiliary driving hole 22 has a substantially hexagonal shape.

Referring to FIG. 7, the auxiliary driving hole 23 has a substantially oblong shape.

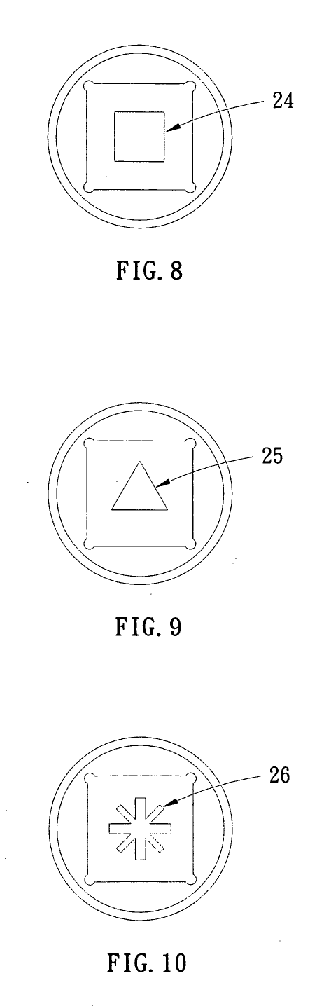

Referring to FIG. 8, the auxiliary driving hole 24 has a substantially square shape.

Referring to FIG. 9, the auxiliary driving hole 25 has a substantially triangular shape.

Referring to FIG. 10, the auxiliary driving hole 26 has a substantially intersecting double cross shape.

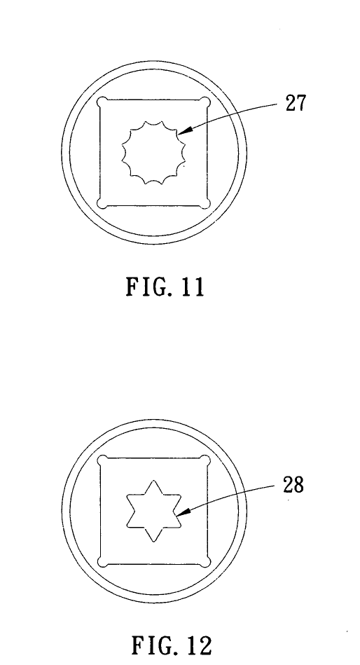

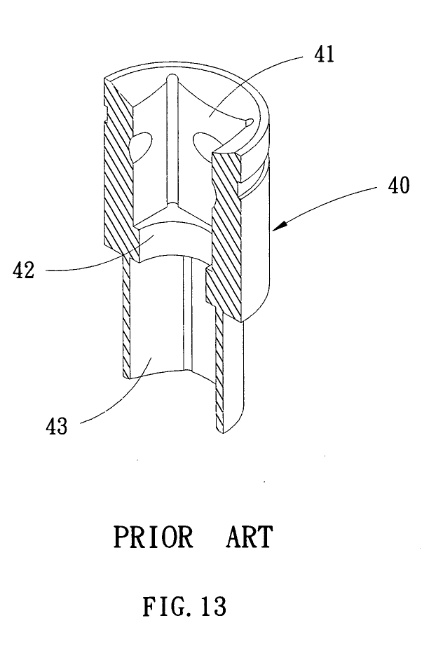

Referring to FIG. 11, the auxiliary driving hole 27 has a substantially plum blossom shape.

Referring to FIG. 12, the auxiliary driving hole 28 has a substantially star shape.

Accordingly, the socket can be driven by a socket wrench and a screwdriver, thereby enhancing the versatility of the socket, and thereby facilitating a user operating the socket. In addition, the socket co-operates with the screwdriver to reduce the space of operation so that the socket co-operating with the screwdriver can be operated in a narrow space. Further, the auxiliary driving hole 20 has different shapes to correspond to screwdrivers of different shapes.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A socket, comprising:
a socket body having a first end formed with a connecting recess, a second end formed with a driving recess and a mediate portion formed with a separation portion which is located between the connecting recess and the driving recess and is formed with an auxiliary driving hole which is connected between the connecting recess and the driving recess; wherein
the auxiliary driving hole is extended through the separation portion;
the auxiliary driving hole has multiple sides;
any two adjacent sides of the auxiliary driving hole form an angled structure
the auxiliary driving hole has a center aligning with an axis of the socket body;
the auxiliary driving hole has a non-circular shape.

2. (canceled)

3. (canceled)

4. The socket in accordance with claim 1, wherein the auxiliary driving hole has a substantially hexagonal shape.

5. (canceled)

6. The socket in accordance with claim 1, wherein the auxiliary driving hole has a substantially square shape.

7. The socket in accordance with claim 1, wherein the auxiliary driving hole has a substantially triangular shape.

8. (canceled)

9. The socket in accordance with claim 1, wherein the auxiliary driving hole has a substantially plum blossom shape.

10. The socket in accordance with claim 1, wherein the auxiliary driving hole has a substantially star shape.

11. The socket in accordance with claim 1, wherein the connecting recess, the auxiliary driving hole and the driving recess are arranged in an axial direction of the socket body.

12. The socket in accordance with claim 1, wherein the separation portion is perpendicular to the axial direction of the socket body.

13. The socket in accordance with claim 1, wherein the separation portion has a thickness extending along the axial direction of the socket body, and the auxiliary driving hole is extended through the whole thickness of the separation portion.

14. (canceled)

15. The socket in accordance with claim 1, wherein the non-circular auxiliary driving hole allows insertion of a non-circular tip of a screwdriver, so that the non-circular auxiliary driving hole of the socket body and the non-circular tip of the screwdriver are combined together, and the socket body is driven and rotated by the screwdriver.

16. The socket in accordance with claim 1, wherein the connecting recess has a square shape.

17. The socket in accordance with claim 1, wherein the driving recess has a hexagonal shape.

18. A socket, comprising:
a socket body having a first end formed with a connecting recess, a second end formed with a driving recess and a mediate portion formed with a separation portion which is located between the connecting recess and the driving recess and is formed with at least one auxiliary driving hole which is connected between the connecting recess and the driving recess; wherein
the auxiliary driving hole has a substantially flat shape;
the auxiliary driving hole is extended through the separation portion;
the auxiliary driving hole has a center aligning with an axis of the socket body.

19. The socket in accordance with claim 18, wherein the separation portion is formed with two flat-shaped auxiliary driving holes;
the auxiliary driving holes intersect each other and have an intersecting position aligning with the axis of the socket body.

20. The socket in accordance with claim 18, wherein the separation portion is formed with four flat-shaped auxiliary driving holes;
the auxiliary driving holes intersect each other and have an intersecting position aligning with the axis of the socket body.
